(19) United States
(12) Patent Application Publication
(10) Pub. No.: US 2004/0087239 A1
(43) Pub. Date: May 6, 2004

(54) Surface conduction electron-emitting device and manufacturing method of image-forming apparatus

(75) Inventors: Taku Shimoda, Kanagawa (JP); Masahiro Terada, Kanagawa (JP); Shosei Mori, Kanagawa (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 10/685,420

(22) Filed: Oct. 16, 2003

(30) Foreign Application Priority Data
Oct. 31, 2002 (JP) 2002-317444

(51) Int. Cl. H01J 9/04

(52) U.S. Cl. 445/50

(57) ABSTRACT

A manufacturing method of forming at low costs a surface conduction electron-emitting device by which microminiaturization can be easily realized and electron-emitting characteristics which are uniform over a large area can be obtained is provided. A resin pattern with ion-exchange performance is formed on a substrate, a solution containing a metal component is absorbed to the resin pattern portion by using a deionization reaction, thereafter, the resin pattern is baked to thereby form an electroconductive thin film, and a forming operation is executed to the obtained electroconductive thin film, thereby manufacturing the surface conduction electron-emitting device.

### BACKGROUND OF THE INVENTION

1. Field of the Invention

The invention relates to a surface conduction electron-emitting device which can be used as an electron source of an image-forming apparatus such as display apparatus like a flat display or the like, exposing apparatus in a copying apparatus or a printer, or the like and to a manufacturing method of the image-forming apparatus using such a device.

2. Related Background Art

As a surface conduction electron-emitting device, a device by Hartwell et al. has been reported (M. Hartwell and C. G. Fonstad, “IEEE Trans. ED Conf.”, 519 (1975)). Such a surface conduction electron-emitting device uses a phenomenon such that electron emission occurs by supplying a current to an electroconductive thin film of a small area formed on a substrate in parallel with a film surface.

It is known that the electroconductive thin film including an electron-emitting region is made of an electroconductive material deposited onto an insulative substrate and formed by using a vacuum evaporation technique or a photolithography technique.

As a forming method of the electroconductive thin film suitable for forming a number of devices over a large area at low costs without needing a vacuum apparatus, a method whereby a droplet of a solution containing an electroconductive material is fed by an ink jet system is also known. With respect to device creation by the ink jet forming system, JP-A-9-102271 and JP-A-2000-251665 can be mentioned. With respect to an example in which those devices are arranged in an XY matrix form, JP-A-64-31332 and J-PA-7-326311 can be mentioned. Further, with respect to a wiring forming method, it has been described in detail in JP-A-8-185818 and JP-A-9-50757. With respect to a driving method, it has been described in detail in JP-A-6-342636 and the like.

In the conventional manufacturing method of the surface conduction electron-emitting device with such a construction as mentioned above, the method of forming the electroconductive thin film by using the vacuum evaporation technique or the photolithography technique has a problem such that although a number of surface conduction electron-emitting devices can be formed over a large area, a special and expensive manufacturing apparatus is needed and production costs are high.

The method by the ink jet system also has a drawback such that there is a limitation in correspondence to microminiaturization and when the surface conduction electron-emitting devices are formed on a large display screen, a tact increases and control to obtain uniformity in shapes and film thicknesses of the devices is difficult.

It is, therefore, an object of the invention to provide a manufacturing method whereby surface conduction electron-emitting devices in which microminiaturization can be easily realized and uniform electron-emitting characteristics can be obtained over a large area are formed at low costs and to provide a manufacturing method of an image-forming apparatus using such a manufacturing method.

### SUMMARY OF THE INVENTION

To accomplish the above object, according to the invention, there is provided a manufacturing method of a surface conduction electron-emitting device, comprising: a resin pattern forming step of forming a resin pattern onto a substrate by using a photosensitive resin having ion-exchange performance; an ion-exchange performance absorbing step of allowing a solution containing a metal component to be absorbed into the resin pattern portion; a step of forming an electroconductive thin film via a baking step of baking the resin pattern; and a step of subjecting the electroconductive thin film to a forming process.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1A is a diagram showing a typical device construction of a surface conduction electron-emitting device as a manufacturing target of the invention;

FIG. 1B is a cross sectional view taken along the line 1B-1B in FIG. 1A;

FIGS. 2A and 2B are explanatory diagrams of an applied voltage in a forming step;

FIGS. 3A and 3B are explanatory diagrams of an applied voltage in an activating step;

FIG. 4 is an explanatory diagram of a forming procedure of the surface conduction electron-emitting device in the embodiment;

FIG. 5 is an explanatory diagram of the forming procedure of the surface conduction electron-emitting device in the embodiment;

FIG. 6 is an explanatory diagram of the forming procedure of the surface conduction electron-emitting device in the embodiment;

FIG. 7 is an explanatory diagram of the forming procedure of the surface conduction electron-emitting device in the embodiment;

FIG. 8 is an explanatory diagram of the forming procedure of the surface conduction electron-emitting device in the embodiment;

FIG. 9 is an explanatory diagram of a measuring evaluating apparatus of electron-emitting characteristics with respect to the surface conduction electron-emitting device obtained in the embodiment; and

FIG. 10 is a graph showing characteristics of the surface conduction electron-emitting device obtained in the embodiment.

### DETAILED DESCRIPTION OF THE PREFERRED EMBODIMENTS

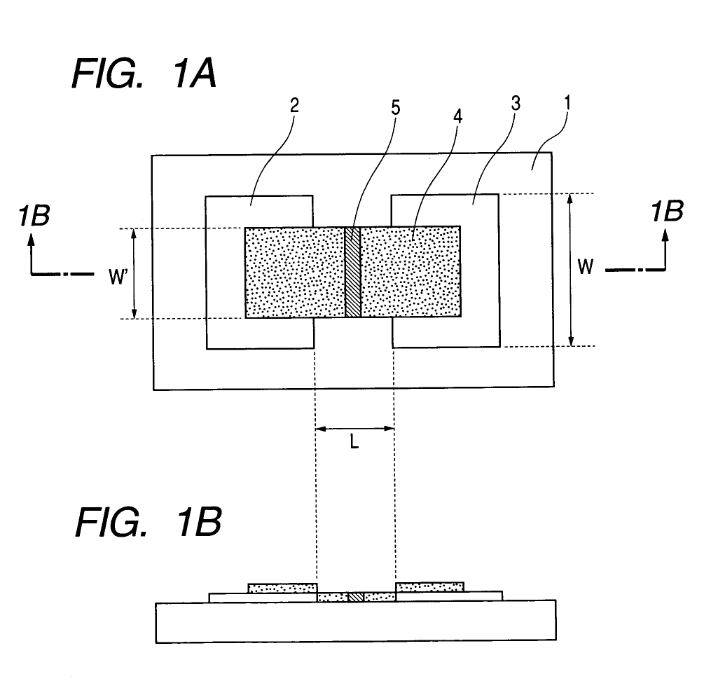

First, the device construction reported by Hartwell et al. mentioned above will be described as a typical device construction of a surface conduction electron-emitting device as a manufacturing target of the invention with reference to schematic diagrams shown in FIGS. 1A and 1B. FIG. 1A is a plan view of the surface conduction electron-emitting device as a typical example. FIG. 1B is a cross sectional view taken along the line 1B-1B in FIG. 1A.

In FIGS. 1A and 1B, reference numeral 1 denotes an electrically insulative substrate made of glass or the like. A size and a thickness of the substrate 1 are properly set in dependence on the number of surface conduction electron-emitting devices which are put on the substrate, a design shape of each device, and in the case where the substrate constructs a part of a vessel when it is used as an electron source, mechanical conditions such as an atmospheric pressure proof structure or the like to keep the inside of the vessel in a vacuum state, and the like.

Soda lime glass, glass in which a content of impurities such as sodium or the like is reduced, quartz glass, glass in which an SiO₂ layer is formed on the surface, a ceramics substrate such as alumina or the like, etc. can be mentioned as a material of the substrate 1.

Device electrodes 2 and 3 are formed on the substrate 1 so as to face each other.

A general electroconductive material is used as a material of the device electrodes 2 and 3. For example, the following materials can be mentioned: a metal such as Pd, Pt, Ru, Ag, Au, Ti, In, Cu, Cr, Fe, Zn, Sn, Ta, W, Pb, etc.; an oxide such as PdO, SnO₂, In₂O₃, PbO, Sb₂O₃, etc.; a boride such as HfB₂, ZrB₂, LaB₆, CeB₆, YB₄, GdB₄, etc.; a carbide such as TiC, ZrC, HfC, TaC, SiC, WC, etc.; a nitride such as TiN, ZrN, HfN, etc.; a semiconductor such as Si, Ge, etc.; carbon; and the like. Preferably, a film thickness of such a material lies within a range from tens of nm to a few μm.

An interval L between the device electrodes 2 and 3, a width W of each side of the device electrodes 2 and 3 which face each other, a width W′ of an electroconductive thin film 4, a shape of the device electrodes 2 and 3, and the like are properly designed in accordance with a use form or the like of the surface conduction electron-emitting device. Preferably, the interval L lies within a range from hundreds of nm to 1 mm. More preferably, the interval L is set to a value within a range from 1 μm to 100 μm in consideration of a voltage that is applied to a portion between the device electrodes 2 and 3 or the like. Preferably, the width W of each side of the device electrodes 2 and 3 which face each other is set to a value within a range from a few μm to hundreds of μm in consideration of an electric resistance value between the device electrodes 2 and 3 and electron-emitting characteristics of the obtained surface conduction electron-emitting device.

The device electrodes 2 and 3 can be obtained by, for example, evaporation-depositing an electroconductive material onto the whole or a part of the substrate 1 by using a vacuum evaporation depositing apparatus. More specifically speaking, after completion of the evaporation deposition, a resist material is coated onto the substrate 1, a predetermined pattern is exposed and developed, a patterned resist is obtained, subsequently, the evaporation-deposited film of a portion without the pattern is removed by using a dry etching apparatus such as RIE or the like, and thereafter, by peeling off the patterned resist by a predetermined solution, the device electrodes 2 and 3 of a desired shape can be obtained.

The device electrodes 2 and 3 can be also formed by coating a commercially available paste containing metal particles of Pt or the like by a printing method such as offset printing or the like. In order to obtain a more precise pattern, they can be also formed by a method whereby a photosensitive paste containing Pt or the like is coated by the printing method such as screen printing or the like and the pattern is exposed and developed by using a photomask.

Usually, after the device electrodes 2 and 3 are formed, the electroconductive thin film 4 on which an electron-emitting region is formed is formed so as to overlap the device electrodes 2 and 3.

To obtain the good electron-emitting characteristics, a particle film made of particles is particularly preferable as an electroconductive thin film 4. A thickness of film 4 is properly set in consideration of the electric resistance value between the device electrodes 2 and 3, forming operation conditions, which will be explained hereinlater, and the like. Preferably, it lies within a range from 1 nm to hundreds of nm. More preferably, it is set to a value within a range from 1 nm to 50 nm. A sheet resistance value is equal to a value within a range of 10³ to 10⁷ Ω/□.

The particle film is a film obtained by collecting a number of particles and includes, as a microminiature structure, not only a film in which the particles are individually dispersed and arranged but also a film in which the particles are adjacent to or overlap each other (also including an island-shape). A diameter of particle lies within a range from 1 nm to hundreds of nm, preferably, from 1 nm to 20 nm.

According to the study by the present inventors et al., it has been found that palladium (Pd) is generally suitable as a material to form the electroconductive thin film 4. However, the invention is not limited to it. A sputtering method, a method of baking after coating a solution, or the like can be properly used as a film forming method.

The electroconductive film is subjected to an energization operation called a forming step, thereby locally destroying, deforming, or altering the electroconductive thin film 4, to form an electrically high resistance region with a fissure portion. Such a region becomes an electron-emitting region 5.

Although the electron-emitting region 5 shown in FIG. 1 is illustrated in a rectangular shape at the center of the electroconductive thin film 4 for convenience of illustration, it is schematically shown and a position and a shape of the actual electron-emitting region 5 are not illustrated with high fidelity.

By arranging a plurality of surface conduction electron-emitting devices mentioned above and forming wirings to drive them, the surface conduction electron-emitting devices can be used as a multi electron source. As such an electron source, there is an electron source with a ladder-like wiring array constructed in a manner such that a plurality of electron-emitting devices each having a pair of device electrodes 2 and 3 are arranged in the X and Y directions in a matrix form, one of the device electrodes 2 and 3 of each of the plurality of surface conduction electron-emitting devices arranged on the same row and the other one of the device electrodes 2 and 3 are connected to the wirings in common, and electrons emitted from the surface conduction electron-emitting devices can be controlled and driven by a control electrode (also called a grid) arranged above each surface conduction electron-emitting device in the direction which perpendicularly crosses the wiring. There can be mentioned another electron source constructed in a manner such that a plurality of surface conduction electron-emitting devices are arranged in the X and Y directions in a matrix form, one of the device electrodes 2 and 3 of each of the plurality of surface conduction electron-emitting devices arranged on the same row is connected to the wiring in the X direction in common, and the other one of the device electrodes 2 and 3 of each of the plurality of surface conduction electron-emitting devices arranged on the same column is connected to the wiring in the Y direction in common. Such an array is what is called a passive matrix array.

As an image-forming apparatus using the surface conduction electron-emitting devices, an apparatus formed by combining the multi electron source as mentioned above and an image-forming member which forms an image by irradiating an electron beam emitted from the surface conduction electron-emitting devices of the electron source can be mentioned. If a member having phosphor which emits visible light by the electrons is used as an image-forming member, a display panel which is used as, for example, a television receiver or a computer display can be formed. If a photosensitive drum is used as an image-forming member and a latent image which is formed on the photosensitive drum by irradiating the electron beam can be developed by using toner, for example, an image-forming apparatus for a copying apparatus or a printer can be formed.

The invention relates to such a surface conduction electron-emitting device and a manufacturing method of the image-forming apparatus as mentioned above. First, the manufacturing method of the surface conduction electron-emitting device will be described in order of a resin pattern forming material which is used in the invention, a solution containing a metal component, a forming method of the electroconductive thin film using them, and steps which are executed after the creation of the device electrodes and the electroconductive thin film.

(1) Resin Pattern Forming Material

As a resin pattern forming material which is used in the invention, a solution of a deionizable resin in which a formed resin pattern can absorb the solution containing the metal component, which will be explained hereinlater, and which reacts on the metal component in the solution containing the metal component or a precursor of such a solution is used. By forming the resin pattern having ion-exchange performance, an absorbing step, which will be explained hereinlater, can be set to an absorbing step of the ion-exchange performance, an absorption amount of the metal component is increased, a use efficiency of the material is improved, and further, a pattern having a better-aligned shape can be formed. It is preferable to use a resin having a carboxylic acid group as an ion-exchangeable resin because it is particularly preferable in terms of shape control of the pattern.

Although the resin pattern forming material is not particularly limited so long as it satisfies the above-mentioned conditions, a photosensitive resin is preferable from a viewpoint of easiness of creation of the pattern. As a photosensitive resin, it is possible to use either a resin of a type in which a photosensitive group is contained in the resin structure or a type in which a sensitive material is mixed in a resin like a cyclized rubber—bisazide system resist. Whichever type of the photosensitive resin component, a photoreactive initiator or a photoreactive inhibitor can be properly mixed. The photosensitive resin can be set to any of a type (negative type) in which a photosensitive resin coated film which is soluble in a developing material is made insoluble in the developing material by the light irradiation and a type (positive type) in which the photosensitive resin coated film which is insoluble in the developing material is made soluble in the developing material by the light irradiation.

Although the photosensitive resin can be either water-soluble or solvent-soluble, a water-soluble photosensitive resin is preferable since a good working environment can be easily maintained, a load of waste which is exercised on the nature is small, and the like. The water-soluble photosensitive resin denotes a photosensitive resin in which development in a developing step, which will be explained hereinlater, can be executed by using water or a developing material containing water of 50 wt % or more. The solvent-soluble photosensitive resin denotes a photosensitive resin in which the development in the developing step is executed by using an organic solvent or a developing material containing the organic solvent of 50 wt % or more.

The water-soluble photosensitive resin will be further explained. As a water-soluble photosensitive resin, it is possible to use a developing material in which water of 50 wt % or more is contained and, for example, lower alcohol such as methyl alcohol, ethyl alcohol, or the like for raising a drying speed in a range less than 50 wt % is added or a developing material in which a component for realizing dissolution acceleration, stability improvement, and the like of the photosensitive resin component is added. It is desirable to use a photosensitive resin by which development can be performed by a developing material in which a content of water is equal to or more than 70 wt % from a viewpoint of reduction of an environment load. It is more preferable to use a photosensitive resin which can be developed by a developing material in which a content of water is equal to or more than 90 wt %. A photosensitive resin which can be developed by a developing material using only water is most preferable. As a water-soluble photosensitive resin, for example, a resin using a water-soluble resin such as polyvinylalcohol system resin, polyvinylpyrrolidone system resin, or the like can be mentioned.

(2) Solution Containing a Metal Component

As a solution containing a metal component which is used in the invention, it is possible to use either an organic solvent system solution using an organic solvent system solvent containing an organic solvent of 50 wt % or more or a water system solution using a water system solvent containing water of 50 wt % or more, so long as a metal or a metal compound film can be formed by baking. As such a solution containing the metal component, it is possible to use a solution in which an organic-solvent-soluble or water-soluble metal organic compound of platinum, silver, palladium, copper, or the like is dissolved as a metal component into an organic solvent system solvent or a water system solvent.

As a solution containing the metal component which is used in the invention, it is preferable to use a water system solution because a good working environment can be maintained, a load of waste which is exercised on the nature is small, and the like in a manner similar to the foregoing photosensitive resin. As a water system solvent of such a water system solution, it is possible to use a solvent in which water of 50 wt % or more is contained and lower alcohol such as methyl alcohol, ethyl alcohol, or the like for raising the drying speed in a range less than 50 wt % is added or a solvent in which a component for realizing dissolution acceleration, stability improvement, and the like of the foregoing metal organic compound is added. However, it is desirable that the content of the water is equal to or more than 70 wt % from a viewpoint of reduction of the environment load. It is more preferable that the content of the water is equal to or more than 90 wt %. It is most preferable that the whole water system solvent is the water.

Particularly, as a water-soluble metal organic compound in which an electroconductive pattern can be formed by baking, for example, a complex compound of gold, platinum, silver, palladium, copper, or the like can be mentioned. Among them, a complex compound containing palladium is preferable because the surface conduction electron-emitting device having excellent electron-emitting characteristics can be easily obtained.

As such a complex compound, a nitrogen contained compound whose ligand has at least one or more hydroxyl group in a molecule is preferable. Further, among complex compounds as nitrogen contained compounds having at least one or more hydroxyl group in a molecule and whose ligand is constructed, for example, it is more preferable to use a complex compound whose ligand is constructed by one or a plurality of kinds of nitrogen contained compounds in which the number of carbons is equal to or less than 8 such as alcohol amine like ethanol amine, propanol amine, isopropanol amine, butanol amine, or the like, serinol, TRIS, and the like.

As reasons why the above complex compound is preferably used, high water-solubility and low crystallization performance can be mentioned. For example, in an ammine complex or the like which is commercially available, there is a case where crystal is deposited during the drying and it is hard to obtain a uniform film. Although the crystallization performance can be lowered by using a “flexible” ligand such as aliphatic alkylamine or the like, there is a case where the water-solubility is deteriorated due to hydrophobic performance of an alkyl group. On the other hand, both of the high water-solubility and low crystallization performance can be accomplished by using the ligand as mentioned above.

Further, to improve film quality of metal or a metal compound pattern which is obtained and improve adhesion with a substrate, for example, it is desirable that a sole element or a compound of rhodium, bismuth, ruthenium, vanadium, chromium, tin, lead, silicon, etc. is contained as a component of the metal compound.

(3) Forming Method of the Electroconductive Thin Film

Usually, after a pair of device electrodes and necessary wirings are formed, the electroconductive thin film is formed so as to overlap both of the device electrodes. However, it is also possible to form the electroconductive thin film in a manner such that it is formed before the device electrodes are formed, after that, the pair of device electrodes are formed so that at least parts of them overlap the electroconductive thin film, respectively, and a part of the electroconductive thin film is exposed from an interval between the pair of device electrodes. The wirings can be formed at any of the following timing, that is: simultaneously with the creation of the device electrodes; before the creation of the device electrodes; and after the creation of the device electrodes. In any of those cases, the electroconductive thin film can be formed by the following steps: 1. a resin pattern forming step (a coating step, a drying step, an exposing step, and a developing step); 2. an absorbing step; 3. a cleaning step which is executed as necessary; 4. a baking step; and further, 5. a milling step which is executed as necessary.

1. Resin Pattern Forming Step

It is a step of forming a resin pattern with the deionization performance onto the substrate by using the resin pattern forming material. Although it can be also formed by forming a resin pattern forming material other than the photosensitive resin onto the substrate by printing, transfer, lift-off, or the like, it is preferable to use the photosensitive resin as a resin pattern forming material and execute the resin pattern forming step by separating it into a coating step, a drying step, an exposing step, and a developing step. The coating step, drying step, exposing step, and developing step will be described hereinbelow.

Coating Step:

It is a step of coating the photosensitive resin onto the electrically insulative substrate where the surface conduction electron-emitting devices should be formed. This coating process can be executed by using one of various printing methods (screen printing, offset printing, flexographic printing, etc.), a spinner method, a dipping method, a spray method, a stamping method, a rolling method, a slit coater method, an ink jet method, and the like.

Drying Step:

It is a step of drying the coated film by volatiling the solvent in the coated film of the photosensitive resin coated onto the substrate in the coating step. Although the coated film can be dried in the room temperature, it is desirable to execute the drying process in a heating state to shorten a drying time. The heat drying process can be performed by using, for example, a dragless oven, a drier, a hot plate, or the like. Although drying conditions differ in dependence on a mixture ratio, a coating amount, or the like of the photosensitive resin to be coated, generally, the coated film can be dried by being put at temperatures of 50 to 100° C. for 1 to 30 minutes.

Exposing Step:

It is a step of exposing the photosensitive resin coated film on the substrate dried in the drying step to a predetermined pattern suitable for use as an electroconductive thin film of the surface conduction electron-emitting device. A range where the coated film is exposed by light irradiation in the exposing step differs in dependence on whether the photosensitive resin which is used is the negative type or the positive type. In the case of the negative type in which the film is made to be insoluble in the developing material by the light irradiation, the coated film is exposed by irradiating the light to a region of the surface conduction electron-emitting device where the electroconductive thin film pattern should be formed. In the case of the positive type in which the film is made to be soluble in the developing material by the light irradiation, the coated film is exposed by irradiating the light to regions other than the region of the surface conduction electron-emitting device where the electroconductive thin film pattern should be formed in a manner opposite to that in the case of the negative type. Selection between the light irradiating region and the non-light irradiating region can be made in a manner similar to the method in the ordinary mask creation by a photoresist.

Developing Step:

It is a step of removing the photosensitive resin coated film in the region other than the region where a desired electroconductive thin film pattern should be formed with respect to the photosensitive resin coated film exposed in the exposing step. If the photosensitive resin is the negative type, the photosensitive resin coated film to which no light is irradiated is soluble in the developing material and the photosensitive resin coated film in the exposed portion to which the light has been irradiated is insoluble in the developing material. Therefore, the photosensitive resin coated film of the non-light irradiating region which is not dissolved in the developing material is dissolved and removed by the developing material, thereby enabling the development to be performed. If the photosensitive resin is the positive type, since the photosensitive resin coated film to which no light is irradiated is insoluble in the developing material and the photosensitive resin coated film in the exposed portion to which the light has been irradiated is soluble in the developing material, the photosensitive resin coated film of the light irradiating region which is dissolved in the developing material is dissolved and removed by the developing material, thereby enabling the development to be performed.

As a developing material, in the case of the water-soluble photosensitive resin, for example, a material similar to the developing material which is used for the water or ordinary water-soluble photoresist can be used. In the case of the solvent-soluble photosensitive resin, an organic solvent or a material similar to a developing liquid which is used for a solvent system photoresist can be used.

2. Absorbing Step

It is a step of absorbing the solution containing the metal component mentioned above into the resin pattern formed via the developing step. In the absorbing step of the invention, since the resin pattern has the deionization performance as mentioned above, it is the absorbing step of the deionization performance. The absorption of the solution containing the metal component is executed by making the formed resin pattern come into contact with the solution containing the metal component. Specifically speaking, for example, such absorption can be performed by the dipping method of dipping the resin pattern into the solution containing the metal component, a coating method of coating the solution containing the metal component onto the resin pattern by, for example, the spray method or spin coating method, or the like. Prior to making the solution containing the metal component come into contact with the resin pattern, for example, in the case of using the water system solution as a solution containing the metal component, the resin pattern can be also swelled by using the water system solvent.

3. Cleaning Step

It is a step of absorbing the solution containing the metal component to the resin pattern and, thereafter, removing the surplus solution deposited onto the resin pattern and the surplus solution deposited onto portions other than the resin pattern. The cleaning step can be executed by a method of dipping the substrate formed with the resin pattern into a cleaning liquid similar to the solvent in the solution containing the metal component by using such a cleaning liquid, a method of blowing the cleaning liquid onto the substrate on which the resin pattern has been formed, or the like. The cleaning step can be also executed by a method of fully peeling off the surplus solution by, for example, blowing the air, vibrating, or the like.

4. Baking Step

It is a step of baking the resin pattern (in the negative type, the photosensitive resin coated film in the light irradiating region; in the positive type, the photosensitive resin coated film in the non-light irradiating region) obtained in the developing step and the absorbing step and, further, the cleaning step as necessary, resolving and removing an organic component in the resin pattern, and forming an electroconductive thin film made of a metal or a metal compound by metal components in the solution containing the metal component absorbed to the resin pattern. Although the baking can be performed in the atmosphere, in the case of an electroconductive thin film made of a metal such as copper, palladium, or the like which is easily oxidized, the baking can be also performed in a vacuum state or in a deoxidation atmosphere (for example, in an atmosphere of inert gases such as nitrogen and the like).

Although the baking conditions also differ in dependence on the kinds of organic components contained in the resin pattern or the like, ordinarily, it can be executed by putting the resin pattern at temperatures of 400 to 600° C. for a few to tens of minutes. The baking can be performed in, for example, a hot-air circulation stove or the like. By the baking, the electroconductive thin film can be formed on the substrate as a film of the metal or metal compound in a shape according to a predetermined pattern.

5. Milling Step

It is executed as necessary after the baking step and is a step of patterning the electroconductive thin film made of the metal or metal compound formed on the substrate. As an ion milling method, any method can be used so long as it is a method which is generally used. As a resist which is used, either a positive resist or a negative resist can be used. As for the exposure, the predetermined pattern can be obtained by exposing the resin pattern by using a predetermined mask and developing. The exposed surface is etched by the ion milling method or the like. As an etching method, any method can be used so long as the metal surface can be etched. Finally, the resist is peeled off. As a peeling liquid, a proper liquid is selected in accordance with the kind of resist used.

(4) Steps After the Device Electrodes and the Electroconductive Thin Film were Formed

After the device electrodes and the electroconductive thin film are formed, the electron-emitting region is formed in the forming step and, preferably, an activating step is further executed, thereby manufacturing an electron-emitting device as a product.

Forming Step:

It is a step of executing an energization operation to the electroconductive thin film and locally destroying, deforming, or altering the electroconductive thin film, thereby forming the electron-emitting region in a state of an electrically high resistance. Usually, the electron-emitting region is in a fissure state.

Forming Step:

In the case of manufacturing, for example, the foregoing multi-electron source in which a plurality of surface conduction electron-emitting devices are arranged in the X direction and the Y direction in a matrix form, a hood-shaped lid is put onto the substrate so as to cover the whole substrate while leaving a lead-out electrode portion around the substrate, a vacuum space is formed between the lid and the substrate, a voltage is applied to a portion between the wirings in the X direction and the Y direction from the lead-out electrode portion by an external power source, and each electroconductive thin film is energized. In this manner, the forming step can be executed. Ordinarily, a resistance value Rs of the electroconductive thin film 4 after the forming operation lies within a range of 10² to 10⁷ Ω.

For example, when the electroconductive thin film is mainly made of palladium oxide (PdO), it is preferable to execute the energization operation in the vacuum atmosphere containing a small quantity of hydrogen gas. By this method, reduction is accelerated by hydrogen at the time of the energization operation, palladium oxide (PdO) changes to palladium (Pd), and the occurrence of the fissure (creation of the electron-emitting region) can be promoted by the reduction contraction of the film at the time of such a change.

An occurring position and a shape of the fissure are largely influenced by the uniformity of the original electroconductive thin film. To suppress a variation in characteristics among the manufactured surface conduction electron-emitting devices, it is desirable that the fissure is linear at the center between the pair of device electrodes.

If the fissure is formed by the forming step, although electrons are emitted from a portion near the fissure at a predetermined voltage, generating efficiency is low if the forming step is merely executed. It is, therefore, preferable to execute an activating step, which will be explained hereinlater.

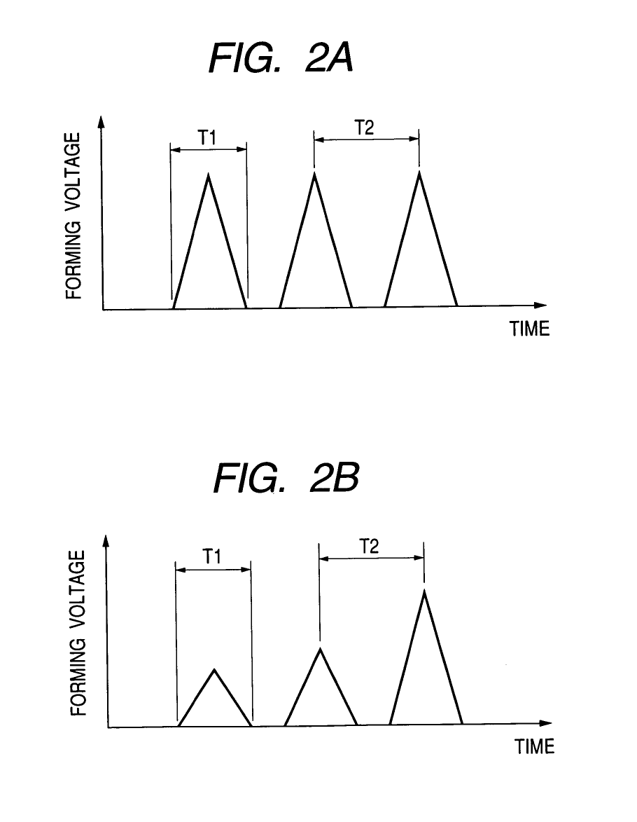

Examples of voltage waveforms at the time of the forming operation are shown in FIGS. 2A and 2B.

It is desirable that the voltage waveform is a pulse waveform. For this purpose, there are a method shown in FIG. 2A whereby a pulse whose pulse peak value is set to a constant voltage is continuously applied and a method shown in FIG. 2B whereby a voltage pulse is applied while increasing the pulse peak value.

In FIG. 2A, T1 and T2 denote a pulse width and a pulse interval of the voltage waveform, respectively. Usually, T1 is set to a value in a range of 1 μsec to 10 msec and T2 is set to a value in a range of 10 μsec to 10 msec. The pulse waveform shown in the diagram is a triangular wave and a peak value of the triangular wave (peak voltage at the time of the forming operation) is properly selected in accordance with the form of the electron-emitting device. Under such conditions, the voltage is applied, for example, for a time interval of a few seconds to tens of minutes. The pulse waveform is not limited to the triangular wave but another waveform such as a rectangular wave or the like can be also used.

With respect to the values of T1 and T2 in FIG. 2B, values similar to those shown in FIG. 2A can be set. A peak value of a triangular wave (peak voltage at the time of the forming operation) in FIG. 2B can be increased step by step of, for example, about 0.1V.

When the forming operation is finished, a voltage of a level which does not locally destroy or deform the electroconductive thin film, for example, a pulse voltage of about 0.1V is inserted between pulses for the forming operations, a device current is measured, a resistance value is obtained, and the forming operation can be finished at a point of time when the resistance value indicates a resistance which is, for example, 1000 or more times as high as that before the forming operation.

The activation operation is a process for remarkably changing the device current and an emission current. This process can be executed by repetitively applying the pulses in the atmosphere containing gases containing carbon atoms in a manner similar to the energization forming operation.

The activating step can be executed as follows. In the case of manufacturing, for example, the multi-electron source in which a plurality of surface conduction electron-emitting devices are arranged in the X direction and the Y direction in a matrix form, in a manner similar to the foregoing forming operation, the hood-shaped lid is put onto the substrate, a vacuum space is internally formed between the lid and the substrate, the pulse voltage is repetitively applied to the device electrodes from the outside via the X-directional wiring and the Y-directional wiring, gases containing carbon atoms are introduced, and carbon or carbon compound which is derived therefrom is deposited as a carbon film onto a portion near the fissure. In this manner, the activation operation can be executed.

The atmosphere containing the gases containing the carbon atoms can be formed by using gases of organic substances remaining in the atmosphere in the case where the inside of the vacuum vessel is exhausted by using, for example, an oil diffusion pump, a rotary pump, or the like. Such an atmosphere can be also obtained by another method whereby gases of proper organic substances are introduced into the vacuum obtained by temporarily sufficiently exhausting the inside of the vacuum vessel by an ion pump or the like.

Since a preferable pressure of the gases of the organic substances at this time differs in dependence on a use purpose of the obtained surface conduction electron-emitting device, the shape of the vacuum vessel, the kinds of organic substances, and the like, it is properly set in accordance with circumstances.

As proper organic substances, an aliphatic hydrocarbon class such as alkane, alkene, or alkyne, an aromatic hydrocarbon class, an alcohol class, an aldehyde class, a ketone class, an amine class, an organic acid class such as phenol, carvone, sulfonic acid, or the like, etc. can be mentioned. Specifically speaking, it is possible to use saturated hydrocarbon expressed by CₙH₂ₙ₊₂ such as methane, ethane, propane, or the like, unsaturated hydrocarbon expressed by a composition formula such as CₙH₂ₙ such as ethylene, propylene, or the like, benzene, toluene, methanol, ethanol, formaldehyde, acetaldehyde, acetone, methyl ethyl ketone, methylamine, ethylamine, phenol, formic acid, acetic acid, propionic acid, or the like, or their mixture.

By the activating step, carbon or the carbon compound is deposited onto the electron-emitting region and a portion near it from the gases containing the carbon atoms existing in the atmosphere, so that the device current and the emission current remarkably change. It is preferable to properly determine the end timing of the activation operation while measuring the device current and the emission current. The pulse width, pulse interval, pulse peak value, and the like for the activation operation are also properly set.

Carbon or the carbon compound is, for example, graphite (containing what is called HOPG, PG, or GC: where, HOPG denotes a crystal structure of almost complete graphite; PG a crystal structure in which a crystal grain diameter is equal to about 20 nm and which is slightly disordered; and GC a crystal structure in which a crystal grain diameter is equal to about 2 nm and which is further largely disordered) or amorphous carbon (showing amorphous carbon or a mixture of amorphous carbon and microcrystal of graphite). It is preferable to set a thickness of the deposited film to a value in a range of 50 nm or less and, more preferably, a range of 30 nm or less.

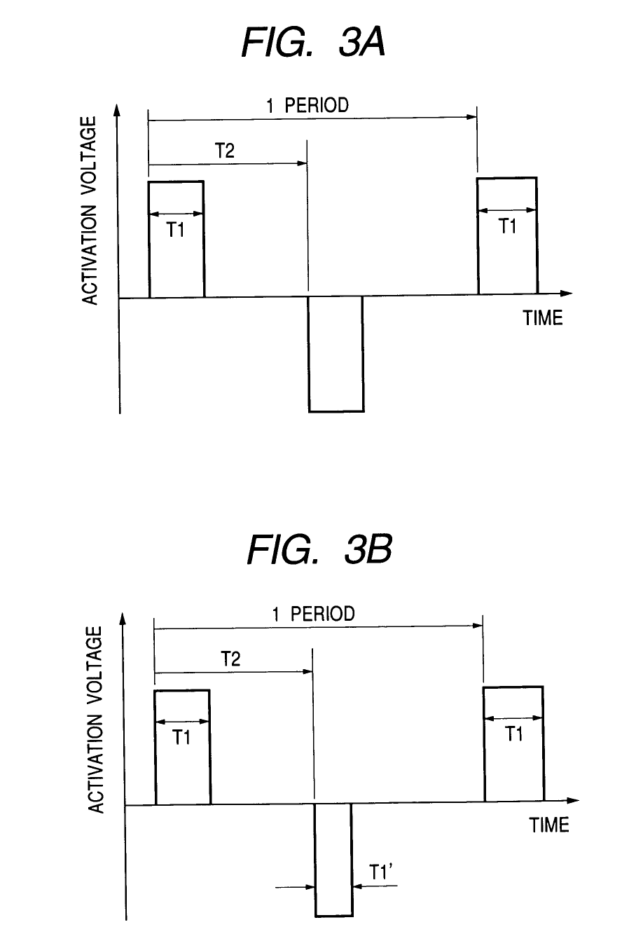

FIGS. 3A and 3B show preferred examples of an applied voltage which is used in the activating step.

As a maximum value of the voltage to be applied, a value in a range of 10 to 20 V is properly selected. In FIG. 3A, T1 denotes the positive and negative pulse widths of the voltage waveform, T2 indicates the pulse interval, and a positive absolute value and a negative absolute value of the voltage value are set to an equal value. In FIG. 3B, T1 and T1′ denotes the positive and negative pulse widths of the voltage waveform, T2 indicates the pulse interval, there is a relation of T1>T1′, and the positive absolute value and the negative absolute value of the voltage value are set to an equal value.

The image-forming apparatus can be manufactured by forming a plurality of electron-emitting devices as mentioned above and combining an image-forming member which forms an image by irradiation of electron beams emitted from the electron-emitting devices.

(Embodiment)

Although the invention will be described in more detail hereinbelow by using embodiments, the invention is not limited by those embodiments.

Embodiment 1

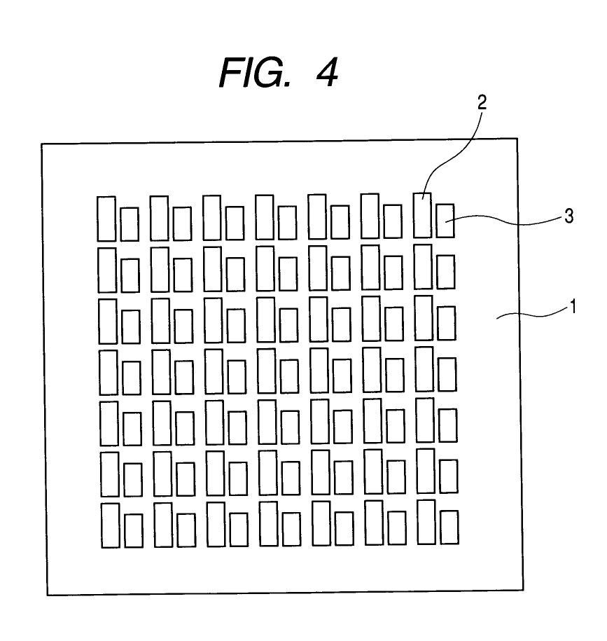

The surface conduction electron-emitting device of the type shown in FIG. 1 is formed by procedures shown in FIGS. 4 to 8.

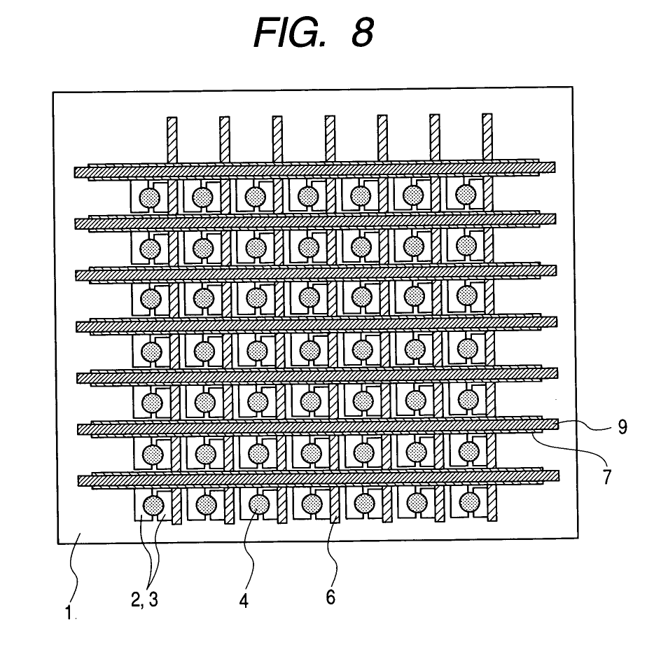

In FIG. 1, reference numeral 1 denotes the substrate; 2 and 3 the device electrodes; 4 the electroconductive thin film; 5 the electron-emitting region; L an interval between the device electrodes 2 and 3; W a width of each of the sides of the device electrodes 2 and 3 which face each other; and W′ a width of the electroconductive thin film 4. In FIGS. 4 to 8, reference numeral 1 denotes the substrate; 2 and 3 the device electrodes; 4 the electroconductive thin film; 6 a wiring in the Y direction; 7 an interlayer insulative layer; 8 a contact hole; and 9 a wiring in the X direction. The electroconductive thin film 4 includes the electron-emitting region (not shown in FIG. 8).

A method of forming the surface conduction electron-emitting device in the embodiment will be described hereinbelow with reference to FIG. 1 and FIGS. 4 to 8.

(A) Creation of the Device Electrodes

First, as shown in FIG. 4, the 49 pairs of device electrodes 2 and 3 are formed onto the substrate 1.

As a substrate 1, an SiO₂ film having a thickness 100 nm is coated and baked as a sodium block layer onto a glass plate “PD-200” containing a small amount of alkali component and made by Asahi Glass Co., Ltd. and a resultant plate (75 mm×75 mm×2.8 mm (thickness)) is used.

Further, as device electrodes 2 and 3, first, as an undercoating layer, a titanium (Ti) film having a thickness 5 nm is formed onto the substrate 1 by a sputtering method and a platinum (Pt) film having a thickness 40 nm is also formed on the Ti film, thereafter, a photoresist is coated, and it is patterned by a photolithography method comprising a series of processes such as exposure, development, and etching, thereby forming the device electrodes. In the embodiment, it is assumed that the interval L between the device electrodes 2 and 3 is set to L=10 μm and the width W of each of the sides of the device electrodes 2 and 3 which face each other is set to W=100 μm.

(B) Creation of the Y-Directional Wiring (Lower Wiring)

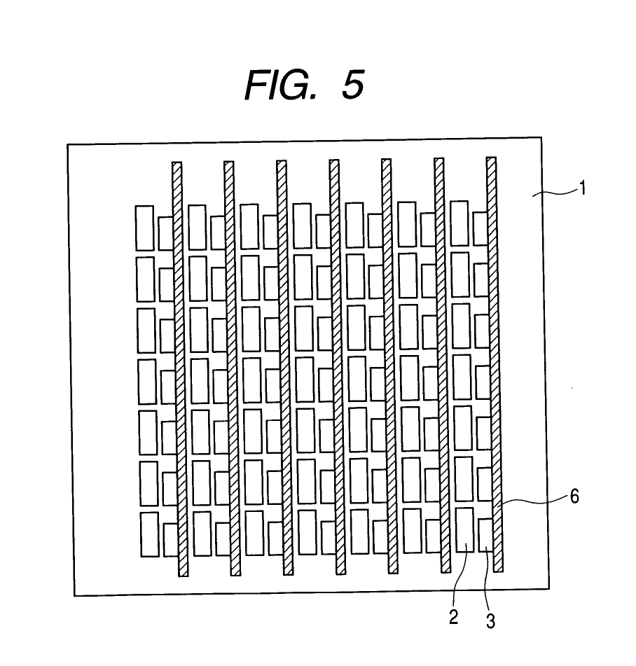

As shown in FIG. 5, the Y-directional wiring (lower wiring) 6 as a common wiring is formed by a line-shaped pattern which is come into contact with the device electrodes 3 and couples them.

Silver (Ag) photopaste ink is used as a material. After a screen is printed, the wiring 6 is dried, exposed to a predetermined pattern, and developed. After that, the pattern is baked at temperatures about 480° C., thereby forming the Y-directional wiring 6.

A thickness of the Y-directional wiring is equal to about 10 μm and its width is equal to 50 μm. A line width of an end portion of the Y-directional wiring is set to be larger in order to use it as a lead-out electrode.

(C) Creation of the Interlayer Insulative Layer

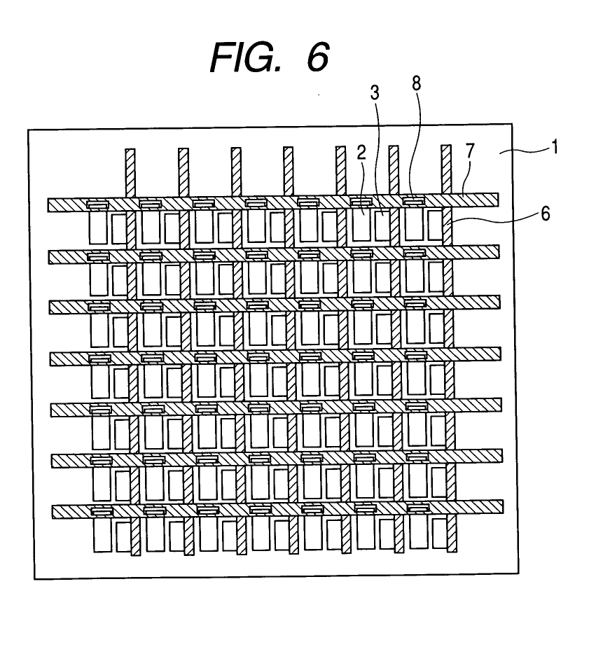

As shown in FIG. 6, in order to insulate the Y-directional wiring 6 from the X-directional wiring (upper wiring) 9, which will be explained hereinlater, the interlayer insulative layer 7 is formed in a line shape from the Y-directional wiring 6 along the forming position of the X-directional wiring 9. The contact hole 8 to obtain an electrical connection of the X-directional wiring 9 and the other device electrode 2 is formed in a position on the device electrode 2.

The interlayer insulative layer 7 is formed by a method whereby steps of screen-printing a photosensitive glass paste containing PbO as a main component and, thereafter, exposing and developing are repeated four times and, finally, it is baked at temperatures about 480° C. A whole thickness of the interlayer insulative layer 7 is equal to about 30 μm and a width is equal to 150 μm.

(D) Creation of the X-directional Wiring (Upper Wiring)

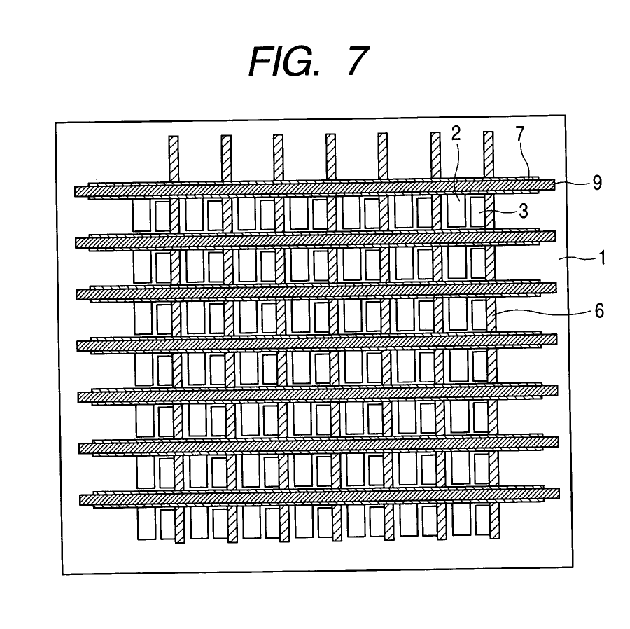

As shown in FIG. 7, the X-directional wiring (upper wiring) 9 as a scanning electrode is formed in a line shape in the direction perpendicular to the Y-directional wiring 6 so as to pass on the contact hole 8.

The X-directional wiring 9 is formed by a method whereby after Ag paste ink is screen-printed onto the interlayer insulative layer 7 which has already been formed, it is dried, similar processes are again executed on it, the Ag paste ink is coated twice, and it is baked at temperatures about 480° C. The obtained X-directional wiring 9 crosses the Y-directional wiring (lower wiring) 6 so as to sandwitch the interlayer insulative layer 7. In the portion of the contact hole 8 of the interlayer insulative layer 7, the obtained X-directional wiring 9 is connected to the other device electrode 2.

A thickness of the X-directional wiring 9 is equal to about 15 μm and a width is equal to 400 μm. Although not shown, a lead-out terminal to an external driving circuit is also formed by a method similar to that of the wiring 9.

(E) Creation of the Electroconductive Thin Film

A solution in which an amine system silane coupling agent (“KBM-603” made by Shin-Etsu Chemical Co., Ltd.) of 0.06 wt % is added to a photosensitive resin (“Sanresiner BMR-850” made by Sanyo Chemical Industries, Ltd.) is coated by a spin coater onto the whole surface of the substrate 1 at a stage where the X-directional wiring (upper wiring) 9 has been formed by the above steps, and the resultant resin is dried at 45° C. for 2 minutes by a hot plate.

Subsequently, a negative photomask is used, the substrate 1 is come into contact with the mask, and the substrate is exposed for an exposing time of 2 seconds by using an extra-high pressure mercury lamp (illuminance: 8.0 mW/cm²) as a light source. Subsequently, pure water is used as a developing material and the substrate is dipped therein for 30 seconds, thereby obtaining the target pattern. A thickness of the film obtained after the resin pattern is formed is equal to 1.1 μm.

The substrate 1 formed with the resin pattern is dipped into the pure water for 30 seconds and, thereafter, it is dipped into a Pd complex aqueous solution (acetic acid palladium—monoethanol amine complex; content of palladium is equal to 0.15 wt %) for 60 seconds.

After that, the substrate 1 is pulled up and cleaned by the flowing water for 5 seconds. The Pd complex aqueous solution between the resin patterns is cleaned. The water is blown out by the air. The substrate is dried at 80° C. for 3 minutes by using the hot plate.

After that, the substrate is baked at 500° C. for 30 minutes by the hot-air circulation stove, thereby forming the electroconductive thin film 4 of palladium oxide (PdO) having a diameter of 60 μm and a thickness of 10 nm (refer to FIG. 8).

An average electrical resistance value of the 49 electroconductive thin films 4 is equal to 20 kΩ with a variation of 2.5%.

(F) Forming

A hood-shaped lid is put onto the substrate 1 so as to cover the whole substrate while leaving the lead-out electrode portion around the substrate 1, a vacuum space is formed between the lid and the substrate 1, a voltage is applied to a portion between the X-directional wiring and the Y-directional wiring from the lead-out electrode portion by the external power source, and each electroconductive thin film 4 is energized.

As a voltage, a pulse voltage of a triangular wave as described in FIG. 2A is applied. T1 in FIG. 2A is set to 0.1 msec, T2 is set to 50 msec, and a peak voltage is set to 12V. Such a pulse voltage is applied, mixture gases of 2 wt % hydrogen and 98 wt % nitrogen are introduced into the space between the substrate 1 and the hood-shaped lid at a pressure increase rate of 5000 Pa per minute, and the electroconductive thin film 4 is reduced. According to the obtained electroconductive thin film 4, a fissure is caused together with the reduction and, after the elapse of ten minutes, the resistance values of all of the electroconductive thin films 4 increase to 1 MΩ or more.

(G) Activation

A hood-shaped lid is put onto the substrate 1 so as to cover the whole substrate while leaving the lead-out electrode portion around the substrate 1, a vacuum space is formed between the lid and the substrate 1, gases containing carbon atoms are supplied into the vacuum space, and a voltage is applied to a portion between the X-directional wiring and the Y-directional wiring from the lead-out electrode portion by the external power source.

In the embodiment, trinitrile is used as a carbon source and introduced into the vacuum space via a slow leak valve, and 1.3×10⁻⁴ Pa is maintained. The rectangular pulse described in FIGS. 3A and 3B is used as a voltage. In FIGS. 3A and 3B, T1, T1′, and T2 are set to 1 msec, 1 msec, and 10 msec, respectively, and the maximum voltage is set to 16V.

At this time, the voltage which is applied to the device electrode 3 is set to be positive and as for a device current If, the direction in which it flows from the device electrode 3 to the device electrode 2 is set to be positive. The energization is stopped at a point of time when an emission current Ie reaches an almost saturated state after the elapse of about 60 minutes, the slow leak valve is closed, and the activation operation is finished.

(H) Characteristics of the Obtained Surface Conduction Electron-Emitting Device

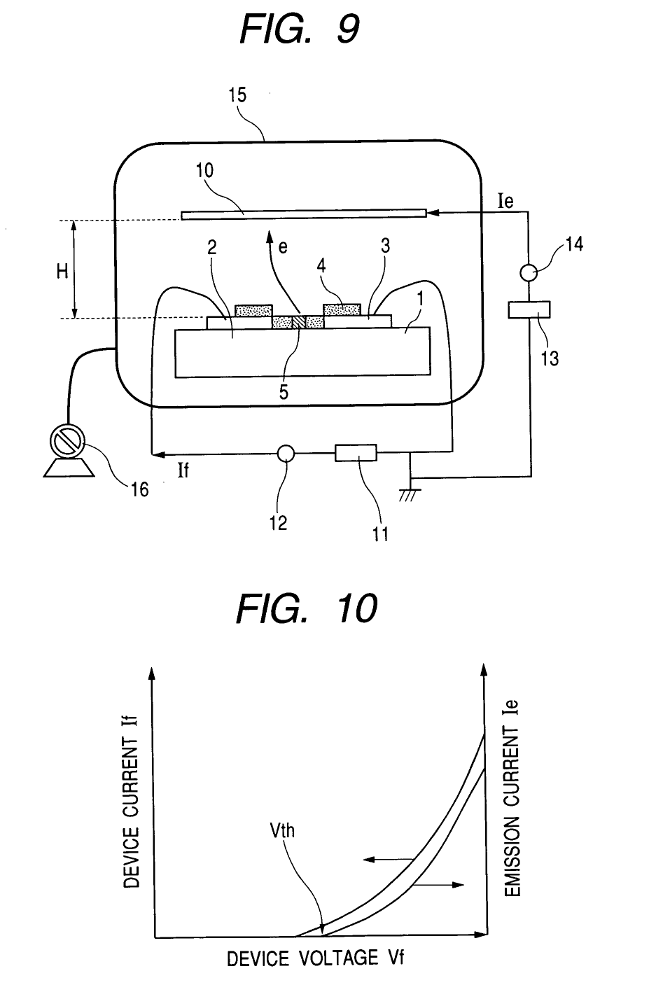

Fundamental characteristics of the surface conduction electron-emitting device formed as mentioned above will be described with reference to FIGS. 9 and 10.

FIG. 9 is a schematic diagram of a measuring evaluating apparatus for measuring electron-emitting characteristics of the surface conduction electron-emitting device having the foregoing construction.

The device current If flowing across the device electrodes 2 and 3 of the surface conduction electron-emitting device and the emission current Ie to an anode electrode 10 are measured. A power source 11 and an ammeter 12 are connected to the device electrodes 2 and 3. The anode electrode 10 to which a high voltage power source 13 and an ammeter 14 are connected is arranged above the surface conduction electron-emitting device to be measured.

In FIG. 9, reference numeral 1 denotes the substrate; 2 and 3 the device electrodes; 4 the electroconductive thin film including the electron-emitting region 5; 5 the electron-emitting region; 11 the power source for applying a device voltage Vf to the device; 12 the ammeter to measure the device current If flowing in the electroconductive thin film 4 including the electron-emitting region 5 between the device electrodes 2 and 3; 10 the anode electrode to capture the emission current Ie emitted from the electron-emitting region 5 of the surface conduction electron-emitting device; 13 the high voltage power source 13 to apply the voltage to the anode electrode 10; and 14 the ammeter to measure the emission current Ie emitted from the electron-emitting region 5 of the surface conduction electron-emitting device.

The surface conduction electron-emitting device and the anode electrode 10 are disposed in a vacuum vessel 15. An exhaust pump 16 and other apparatuses are equipped in the vacuum vessel 15, thereby enabling the surface conduction electron-emitting device to be measured and evaluated under a desired vacuum environment.

In the embodiment, a voltage of the anode electrode 10 is set to 400V and a distance H between the anode electrode 10 and the surface conduction electron-emitting device is set to 4 mm.

FIG. 10 shows a typical example of relations among the emission current Ie and the device current If measured by the measuring evaluating apparatus shown in FIG. 9 and the device voltage Vf. Although the magnitudes of the emission current Ie and the device current If are remarkably different, in FIG. 10, an axis of ordinate is expressed by an arbitrary unit on a linear scale for the purpose of making qualitative comparison and examination of changes of If and Ie.

The emission current Ie at the voltage 12V which is applied across the device electrodes 2 and 3 (refer to FIG. 9) is measured, so that an average value is equal to 0.6 μA and an average electron emitting efficiency is equal to 0.17%. Uniformity among the surface conduction electron-emitting devices is good. A variation of Ie among the surface conduction electron-emitting devices is equal to 9%, so that a good value is obtained.

As described above, in the case where the surface conduction electron-emitting devices are formed in accordance with the invention, the surface conduction electron-emitting devices with more excellent uniformity and at lower costs than those of the devices formed by the prior art can be manufactured. Since a number of surface conduction electron-emitting devices can be easily formed over a large area by using the surface conduction electron-emitting devices, an image-display apparatus having excellent display quality can be realized at low costs.

As many apparently widely different embodiments of the present invention can be made without departing from the spirit and scope thereof, it is to be understood that the invention is not limited to the specific embodiments thereof except as defined in the appended claims.

What is claimed is:

1. A manufacturing method of a surface conduction electron-emitting device, comprising:
a resin pattern forming step of forming a resin pattern onto a substrate by using a photosensitive resin having ion-exchange performance;
an ion-exchange performance absorbing step of allowing a solution containing a metal component to be absorbed into said resin pattern portion;
a step of forming an electroconductive thin film via a baking step of baking said resin pattern; and
a step of subjecting said electroconductive thin film to a forming process.

2. A method according to claim 1, wherein said solution containing the metal component is a complex compound containing at least palladium.

3. A method according to claim 1, further comprising an activating step of applying a pulse to said electroconductive thin film in an atmosphere containing gases containing carbon atoms, after said step of the forming process.

4. A method according to claim 1, wherein said resin pattern forming step includes:
a coating step of coating said photosensitive resin onto a surface of the substrate;
a drying step of drying said photosensitive resin after the coating, thereby obtaining a coated film;
an exposing step of exposing said coated film to a predetermined pattern; and
a developing step of removing an exposed region or a non-exposed region of said coated film.

5. A manufacturing method of an image-forming apparatus comprising a plurality of electron-emitting devices and an image-forming member for forming an image by irradiation with electron beams emitted from said electron-emitting devices, wherein said electron-emitting devices are formed by a method according to claim 1.
